(19) United States
(12) Patent Application Publication
(10) Pub. No.: US 2022/0067648 A1
(43) Pub. Date: Mar. 3, 2022

(54) Virtual Tracking Number

(71) Applicant: eBay Inc., San Jose, CA (US)

(72) Inventors: Yi Zhao, Redmond, WA (US); Thilagaraj Shunmugaiah, Fremont, CA (US); Can Yalkin, San Jose, CA (US); Shakul Hameed, San Jose, CA (US); Sidharth Bhasin, Santa Clara, CA (US); Edna Pawana Dsouza, Snohomish, WA (US)

(73) Assignee: eBay Inc., San Jose, CA (US)

(21) Appl. No.: 17/022,012

(22) Filed: Sep. 15, 2020

Related U.S. Application Data
(60) Provisional application No. 63/071,975, filed on Aug. 28, 2020.

(51) Int. Cl. G06Q 10/08; G06Q 30/04

(52) U.S. Cl. CPC G06Q 10/0833; G06Q 30/04

(57) ABSTRACT

Virtual tracking number techniques and systems are described which overcome conventional challenges to support tracking of shipment of physical items as part of digital services. In one example, the virtual tracking number is generated automatically as part of a shipping address by a service provider system that implements the digital services. Inclusion of the virtual tracking number is then identified by a shipping provider system and used to form a communication that indicates a shipping tracking number used to track shipment of the physical item. The service provider system may then expose a user interface that indicates this shipping tracking number to a sender and a recipient and is usable to obtain tracking information from the shipping provider system.

The application claims priority to U.S. Provisional Patent Application No. 63/071,975, filed Aug. 28, 2020, Attorney Docket Number IP-P3556PRV, and titled “Virtual Tracking Number,” the entire disclosure of which is hereby incorporated by reference.

### BACKGROUND

### Background

Digital services as implemented by computing devices are used to make a wide range of functionality available via the network. Examples of such functionality include facilitating transfer of a physical item between users. A digital service, for instance, may be configured to provide digital content that describes arts and crafts created by an artist that are available to be procured by other users. Other instances involve online auctions in which bidders access digital content describing the physical item to provide bids via a platform implemented by the digital services, auto buying services, and so forth.

However, conventional techniques used to integrate shipping of the physical item as part of these digital services have encountered numerous challenges. For example, technology used by the digital services to aid tracking of shipment of the physical items through conventional distribution channels has largely been limited to manual input and disparate seller-based reporting systems. Conventional reporting systems generally require that manual input of tracking numbers provided by shipping provider systems (e.g., common carriers) for each transaction, and continually devote time and computing resources to update tracking data to accurately and correctly input tracking numbers in a timely manner Therefore, use of conventional reporting systems encounter challenges due to the different designs and systems of conventional distribution channels, which present a number of technical challenges with respect to the integration of automated post-sales tracking across different conventional distribution channels and shipping provider systems, e.g., common carriers.

Manual input of tracking numbers is also problematic in conventional techniques. In real-world scenarios, tracking numbers are input incorrectly or inaccurately, are input late, or are not even entered at all. Therefore, in such scenarios, conventional techniques result in bad transactional experiences, user frustration, lower user retention, inefficient transactions for the involved parties, and inefficient use of network and computational resources.

### SUMMARY

Virtual tracking number techniques and systems are described which overcome conventional challenges to support tracking of shipment of physical items as part of digital services. In one example, the virtual tracking number is generated automatically as part of a shipping address by a service provider system that implements the digital services. Inclusion of the virtual tracking number is then identified by a shipping provider system and used to form a communication that indicates a shipping tracking number used to track shipment of the physical item. The service provider system may then expose a user interface that indicates this shipping tracking number to a sender and recipient and is usable to obtain tracking information from the shipping provider system.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of an environment in an example implementation that is operable to employ virtual tracking number techniques described herein.

FIG. 2 depicts a system in an example implementation in which a recipient client device selects a physical item made available via a digital service of a service provider system to be shipped to a user associated with the recipient client device.

FIG. 3 depicts a system in an example implementation in which a sender client device initiates generation of a shipping address by a service provider system that is to include a virtual tracking number.

FIG. 4 depicts a system in an example implementation in which a shipping address is generated by a service provider system that includes a virtual tracking number as an integral part, thereof.

FIG. 5 depicts a system in an example implementation in which a shipping provider system detects a virtual tracking number included as part of a shipping address, and in response, communicates a shipping tracking number associated with the shipping of the physical item by the shipping provider system to the service provider system.

FIG. 6 depicts a system in an example implementation in which a shipping tracking number received from a shipping provider system in response to identification of a virtual tracking number in FIG. 5 is used to obtain tracking data describing characteristics involving shipping of a physical item by the shipping provider system.

FIG. 7 is a flow diagram depicting a procedure in an example implementation in which a virtual tracking number is leveraged by a sender client device as part of shipping a physical item as part of a digital service.

FIG. 8 depicts a system in an example implementation shown using first, second, and third stages including selection of a physical item, display of a shipping address that includes the virtual tracking number as an integral part thereof, and display of tracking data.

FIG. 9 is a flow diagram depicting a procedure in an example implementation in which a virtual tracking number is leveraged by a recipient client device as part of shipping a physical item as part of a digital service.

FIG. 10 depicts a system in an example implementation shown using first, second, and third stages including selection of a physical item to be obtained through interaction with digital content, display of a shipping tracking number obtained from a shipping provider system using the virtual tracking number, and display of tracking data.

FIG. 11 is a flow diagram depicting a procedure in an example implementation in which a service provider system generates and leverages a virtual tracking number.

FIG. 12 illustrates an example system including various components of an example device that can be implemented as any type of computing device as described and/or utilize with reference to FIGS. 1-11 to implement embodiments of the techniques described herein.

### DETAILED DESCRIPTION

### Overview

Conventional techniques for reporting tracking numbers of physical items obtained via digital services are often inaccurate or incorrect, create unnecessary delays, or result in missing tracking numbers, causing bad, unreliable transactional experiences, user frustration, lower user retention, inefficient online transactions for the involved parties, and inefficient use of network and computational resources. Thus, users of the digital services are subject to these inefficiencies, despite the continued advances in computing technologies to enable their various physical items to be surfaced to client devices and electronically purchased over the Internet.

As a result, in many scenarios, users experience frustration with the digital services when interacting with conventional distribution channels and continue to be burdened by the increasing complexity in the manual administration and management of shipment of physical items. This is also problematic for service provider systems because even the service provider system is unable to verify, on behalf of users, that a physical item has been sent by one entity and delivered to another.

Accordingly, systems and techniques are described to generate, disseminate, and leverage virtual tracking codes to overcome these and other challenges involving shipping of a physical item as part of a digital service. A service provider system, for instance, may be configured as an intermediary and platform that supports interaction with client devices via digital services via digital content. Examples of digital services include physical items that relate to arts, crafts, furniture, tools, third-party ecommerce platforms in which physical items are made available for purchase (e.g., via auction or specified amount), ticketing services, vehicle sales services, classified advertising services, and so forth.

In one example, a sending client device interacts with a service provider system to generate digital content describing a physical item. The digital content, for instance, may include a webpage, a social media post, a product listing, and so forth. The service provider system then makes this digital content available via a network (e.g., the Internet) to increase awareness of these physical items to other users of the platform. These other users may thus access this platform and make arrangements to obtain the physical item, such as to provide billing information, a physical address to ship the physical item to, and so forth.

In response, the service provider system in this example generates a virtual tracking number that is to be included as an integral part of the shipping address that is to be used to ship the physical item. Examples of virtual tracking numbers include letters, numbers, symbols, and so forth. The virtual tracking number is automatically generated as a line in the shipping address. The shipping address, for instance, may include a first line identifying an entity (e.g., a person, a business) that is to receive the physical item, a second line including the virtual tracking number, a third line include a street address, and a fourth line including a city, state, and zip code. The generated virtual tracking number may be provided to the sending client device (i.e., the provider of the physical good) in a variety of ways including instant messaging, electronic messages, email, and so forth.

The modified shipping address, which includes the generated virtual tracking number as an integral part thereof, is thus configured to be leveraged by the service provider system, shipping provider system, or recipient client device without further actions taken on the part of the sender client device. The sender client device, for instance, may including the shipping address on a physical label that is attached to packaging used to ship the physical item. Other instances are also contemplated, such as manual entry to a user interface of the shipping provider system.

When the physical item is received by the shipping provider system, such as a common carrier, the shipping provider system scans or processes the package of the physical item using existing techniques, including recording the shipping address including the virtual tracking number. This scan may be performed in a variety of ways, such as using an optical scanner, RFID scanner, and so forth. Upon scanning the package, the shipping provider system identifies the virtual tracking number. From this, the shipping provider system may identify a service provider system that corresponds to the virtual tracking number and in response communicate data that indicates the virtual tracking number is associated with a shipping tracking number used by the shipping provider system to track shipment of the physical item.

Upon receipt of this data by the service provider system, the service provider system updates identifier data associated with the physical item to reflect the shipping tracking number used by the shipping provider system. In one implementation, a sender and/or recipient may receive a notification notifying them of this update without the sender manually inputting the shipping tracking number per conventional techniques. In this way, the described techniques improve the efficiency of transactions between users of digital services and reduces computational resource consumption and improves an overall user experience.

In the following discussion, an example environment is described that may employ the techniques described herein. Example procedures are also described which may be performed in the example environment as well as other environments. Consequently, performance of the example procedures is not limited to the example environment and the example environment is not limited to performance of the example procedures.

### Example Environment

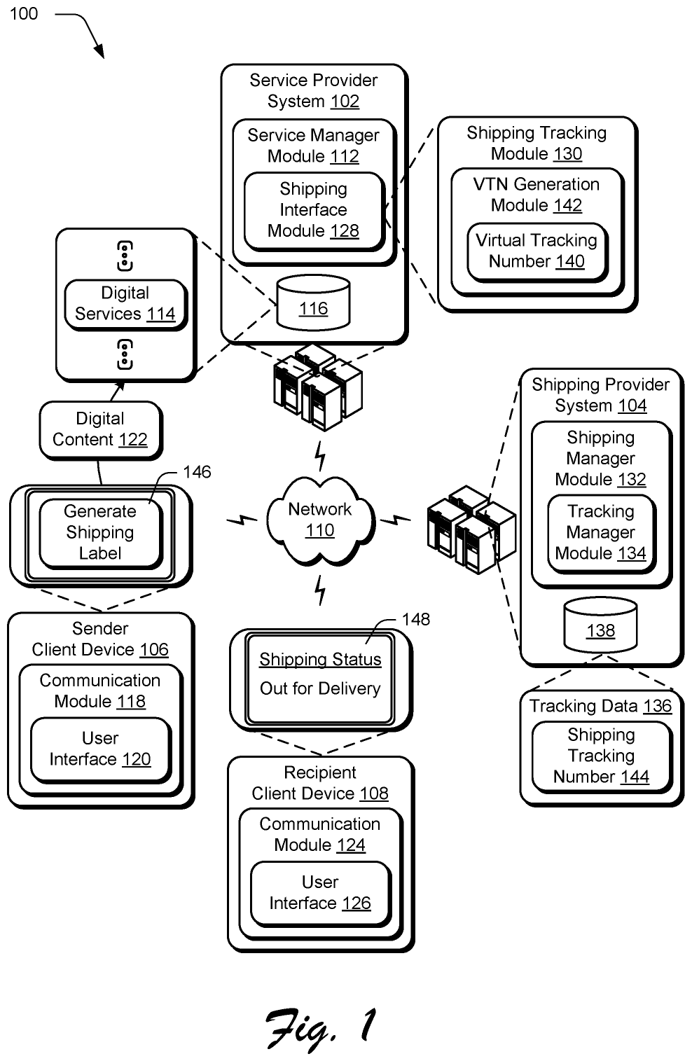

FIG. 1 is an illustration of a digital medium environment 100 in an example implementation that is operable to employ techniques described herein. The illustrated environment 100 includes a service provider system 102, a shipping provider system 104, a sender client device 106, and a recipient client device 108 that are communicatively coupled, one to another via a network, e.g., the Internet. These entities are implemented using computing devices, which are configurable in a variety of ways.

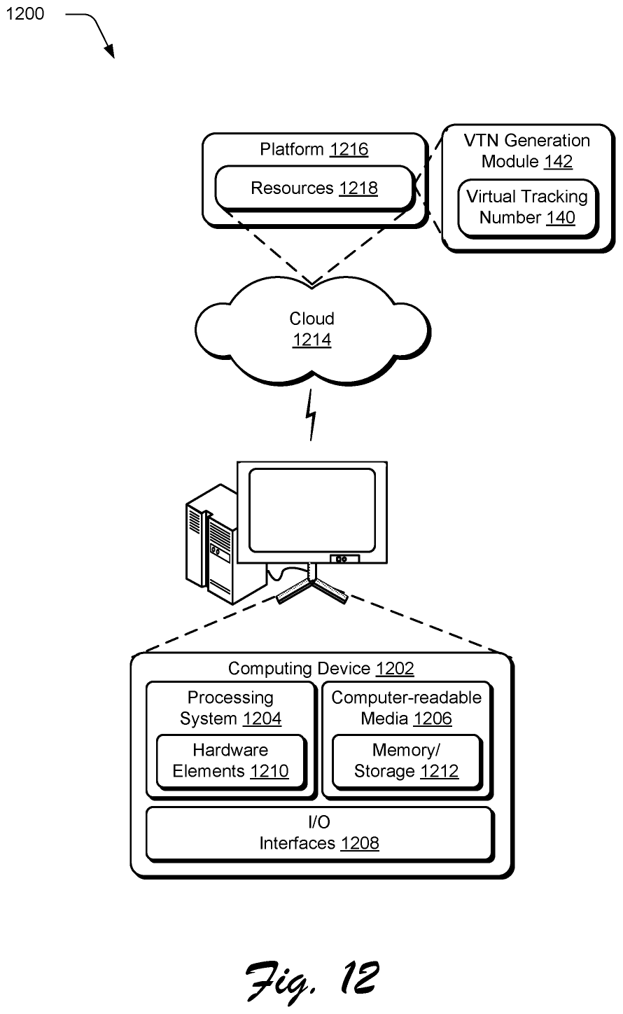

A computing device, for instance, may be configured as a desktop computer, a laptop computer, a mobile device (e.g., assuming a handheld configuration such as a tablet or mobile phone), and so forth. Thus, a computing device may range from full resource devices with substantial memory and processor resources (e.g., personal computers, game consoles) to a low-resource device with limited memory and/or processing resources (e.g., mobile devices). Additionally, although a single computing device is shown and described in some instances, a computing device may be representative of a plurality of different devices, such as multiple servers utilized by a business to perform operations “over the cloud” as described in FIG. 12 and as illustrated for the service provider system 102 and the shipping provider system 104.

The service provider system 102 includes a service manager module 112 that is configured to manage, execute, and expose digital services 114 (illustrated as stored in a storage device 116) that are made available via the network 110. Digital services 114 involve electronic delivery of data via the network 110, which may support a wide variety of functionality, such as digital streaming, content delivery, social networks, intermediary platforms, and so on. A sender client device 106, for instance, may include a communication module 118 that exposes a user interface 120 to access the digital services 114 via a network, such as to generate digital content 122, such as a webpage, social media post, offering for a physical item (e.g., for purchase), and so forth. This digital content 122 may then be accessed by a recipient client device 108 using a corresponding communication module 124 and user interface 126. Examples of communication modules 118, 124 that are executable by the respective client devices (and more particularly via a processing system and computer-readable storage media as described in relation to FIG. 12) include browsers, network-enabled applications, plug-in modules, and so forth.

In the illustrated example, the digital services 114 involve, directly or indirectly, shipment of a physical item, e.g., from a sender client device 106 to a recipient client device 108. The digital service 114 made available by the service provider system 102, for instance, may include a social network service, ecommerce platform (e.g., online auction via digital bids, support direct purchase, craft goods platform, etc.), and so on in which a physical item in possession of a user associated with a sender client device 106 is to be shipped to a physical address of a user of the recipient client device 108.

Therefore, to support such functionality, the service provider system 102 includes a shipping interface module 128 and a shipping tracking module 130. These modules are configured to interact with a shipping provider system 104 through communication of data via the network 110 to provide digital services 114 that support physical shipping of the physical item.

The shipping provider system 104, for instance, includes a shipping manager module 132 that is configured to support physical shipping of the physical item. This includes processing of payment information to pay for shipping of the physical item, maintaining data of physical addresses of the sender and recipient, as well as employing a tracking manager module 134 that generates and maintains tracking data 136 that describes a shipping status of the physical item.

The tracking data 136, which is illustrated as being maintained by a storage device 138, describes a variety of information involving shipping of the physical item by the shipping provider system 104. Examples of this information described by the tracking data 136 include a general shipping stage (e.g., label printed, picked up, in transit, out-for-delivery), times at which these stages have been initiated, corresponding locations, characteristics of the physical item (e.g., size, weight, packing materials used), shipping cost, insurance information, and so forth. This tracking data 136 may be obtained by the shipping tracking module 130 and provided to corresponding sender and recipient client devices 106, 108 indirectly through the service provider system 102 and/or directly through direct communication between the sender and recipient client devices 106, 108 with the shipping provider system 104.

In the illustrated digital medium environment, the shipping tracking module 130 supports a virtual tracking number (VTN) 140 generated by a VTN generation module 142. The VTN 140 is configured to address the shortcomings and challenges of conventional techniques involving shipment of a physical item. For example, in some conventional techniques a sender of the physical item is tasked with provided a shipping tracking number 144 usable by the tracking manager module 134 to locate tracking data 136 that corresponds to shipment of the physical item by the shipping provider system 104. However, in the real world, it has been observed that a significant portion of the senders fail to upload the shipping tracking number 144 of the service provider system 102, and thus this information is not made available to the recipient client device 108. In other real-world examples, there is often a delay in this upload, there may be errors in uploading the tracking number (e.g., caused by manual entry of the number), there may be changes made to the tracking number, and so on. This results in further delay and inefficient use of computational resources used to provide the tracking data 136 (e.g., to the sender and recipient client devices 106, 108), as well as a diminished user experience with the service provider system 102.

To address these challenges, the service provider system 102 employs a VTN 140 generated by the VTN generation module 142 that is configured to aid collection and dissemination of tracking data 136 with improved efficiency both timewise and with respect to computational resources expended by the service provider system 102 and shipping provider system 104 to provide insight into shipment of a physical object. In one example, the VTN generation module 142 is configured to generate the VTN 140 as part of a shipping address to ship a physical item, e.g., from the sender client device 106 to the recipient client device 108. The shipping interface module 128, for instance, may output an option 146 displayable in the user interface 120 of the sender client device 106 to generate a shipping label. In response, the VTN generation module 142 generates the VTN 140 and includes it as an integral part of the shipping address, e.g., as a second line in the recipient's physical address. In this way, once the sender client device 106 prints that physical label that includes the shipping address, the VTN 140 is available on the packaging.

This allows the shipping provider system 104 to detect the VTN 140, identify the service provider system 102 (and more particularly a URL or other network address associated with the system), and communicate a shipping tracking number 144 used by the shipping provider system 104 itself to track the shipment back to the service provider system 102, i.e., the communication indicates the VTN 140 is associated with the shipping tracking number 144. The service provider system 102 stores this correlation in the storage device 116 and also shares this information, e.g., with the sender client device 106 and/or the recipient client device 108. In this way, the VTN 140 supports automatic communication of the shipping tracking number 144 and corresponding tracking data 136 without further user interaction on the part of the sender client device 106. This further supports increased efficiency in communication of this information to the recipient client device 108, i.e., a user associated with the recipient client device 108 may receive tracking data 136 sooner than was otherwise the case in typical real-world scenarios. Further discussion of these examples is included in the following sections and shown using corresponding figures.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

Virtual Tracking Number

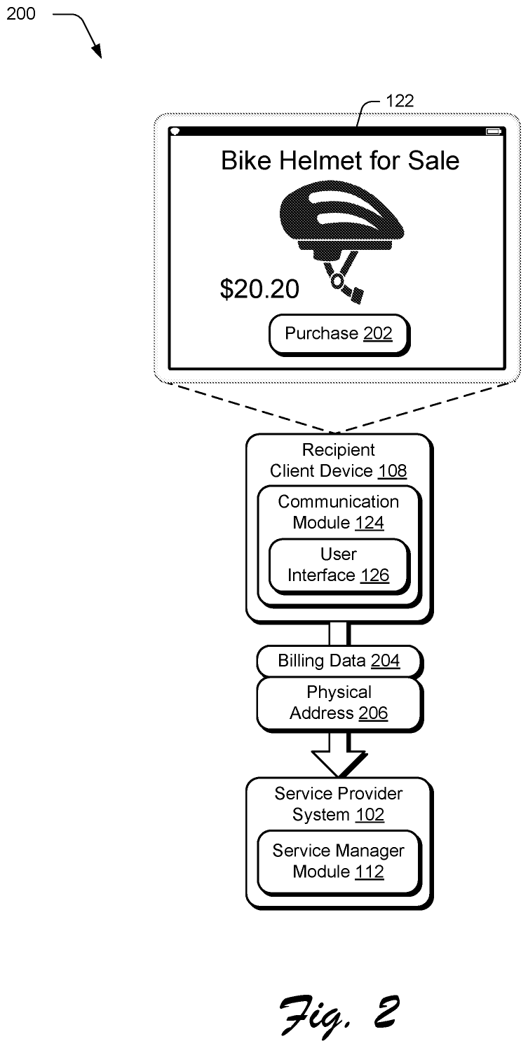

FIGS. 2-6 depict examples of generation, dissemination, and use of a VTN 140 by the service provider system 102, shipping provider system 104, sender client device 106, and recipient client device 108 of FIG. 1. Although described using these entities, functionality described to implement these techniques may be further combined (e.g., the service and shipping provider system 102, 104 as a single entity) or distributed without departing from the sprit and scope thereof.

To begin in this example, FIG. 2 depicts a system 200 in an implementation in which a recipient client device 108 selects a physical item made available via a digital service 114 of the service provider system 102 to be shipped to a user associated with the recipient client device 108. The user interface 126 as output by the recipient client device 108 includes a display of digital content 122 generated by the sender client device 106, which is received via a digital service 114 implemented by the service provider system 102.

The service provider system 102, for instance, may act as a platform that connects entities (e.g., the sender and recipient client devices 106, 108) and in this example involves transfer of a physical item from one entity to another. Examples of such digital services 114 include physical items that relate to arts, crafts, furniture, tools, third-party ecommerce platforms in which physical items are made available for purchase (e.g., via auction or specified amount), ticketing services, vehicle sales services, classified advertising services, and so forth.

In the illustrated example, digital content 122 is generated by the sender client device 106 of a physical item that is made available, e.g., a bike helmet for purchase. The digital content 122 may take a variety of forms, such as a webpage, user interface screen, social media post, or any other form capable of dissemination across the network 110. The digital content 122 is disseminated by the service provider system 102 via the network 110 and obtained by the recipient client device 108. In order to purchase the physical item, the recipient client device 108 interacts with the user interface 126 to select an option 202 to purchase the item. In response, continued user interaction occurs to provide billing data 204, such as user's name, billing address, account information (e.g., credit card number, expiration date, CCV code), and so forth.

A physical address 206 is also provided, to which, the physical item is to be shipped. The physical address 206 and corresponding named entity may be the same or different from the billing address and/or purchaser's name. This data is communicated via the network 110 to the service provider system 102 and processed by the service manager module 112 to complete the purchase of the physical item. Once completed, this information is provided to the sender client device 106, an example of which is described in the following.

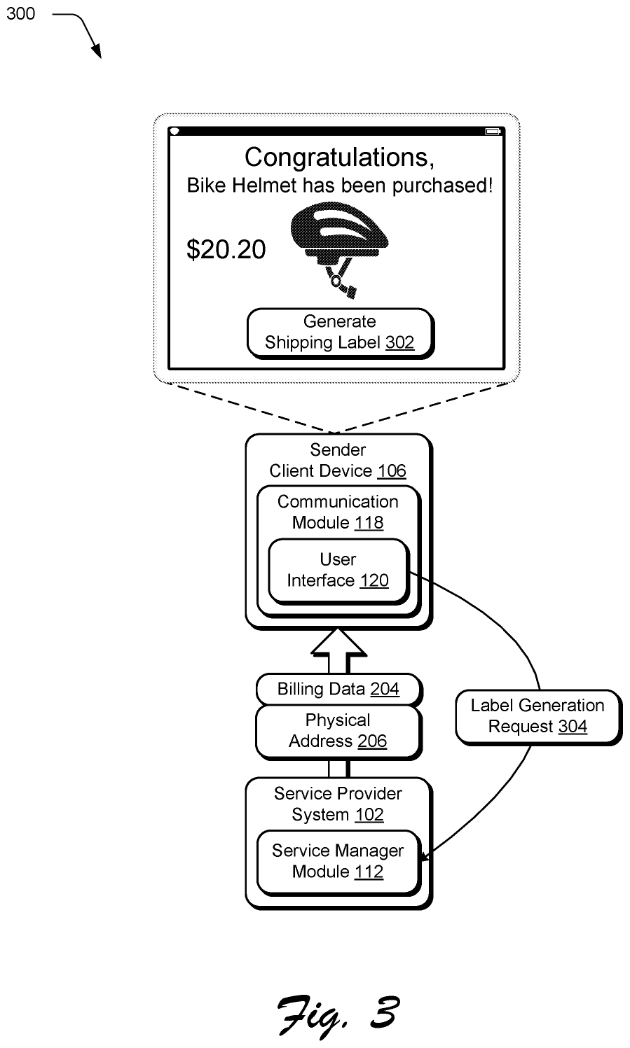

FIG. 3 depicts a system 300 in an example implementation in which the sender client device 106 initiates generation by the service provider system 102 of a shipping address that includes a VTN 140. In the illustrated example, information describing purchase of the physical item by the recipient client device 108 is communicated from the service provider system 102 to the sender client device 106. This information may take a variety of forms, such as an indication that the item was purchased, an identifier of the physical item, a purchase price of the physical item (e.g., in an online auction scenario), billing data 204, physical address 206, and so forth. Examples of this information are illustrated as displayed in the user interface 120 output by the sender client device 106.

The user interface 120 also includes an option 302 that is user selectable to initiate generation of a shipping address. In the illustrated example, this option 302 is selectable to form a label generation request 304 to generate the shipping address to be included as part of a physical label, e.g., printed by the sender client device 106. Other examples are also contemplated, such as to output the shipping address in the user interface to support “cut-and-paste” functionality for input via a user interface to the shipping provider system 104, and so forth. Accordingly, the service provider system 102 receives the label generation request 304 via the network 110, which prompts generation of the shipping address as further described in the following example.

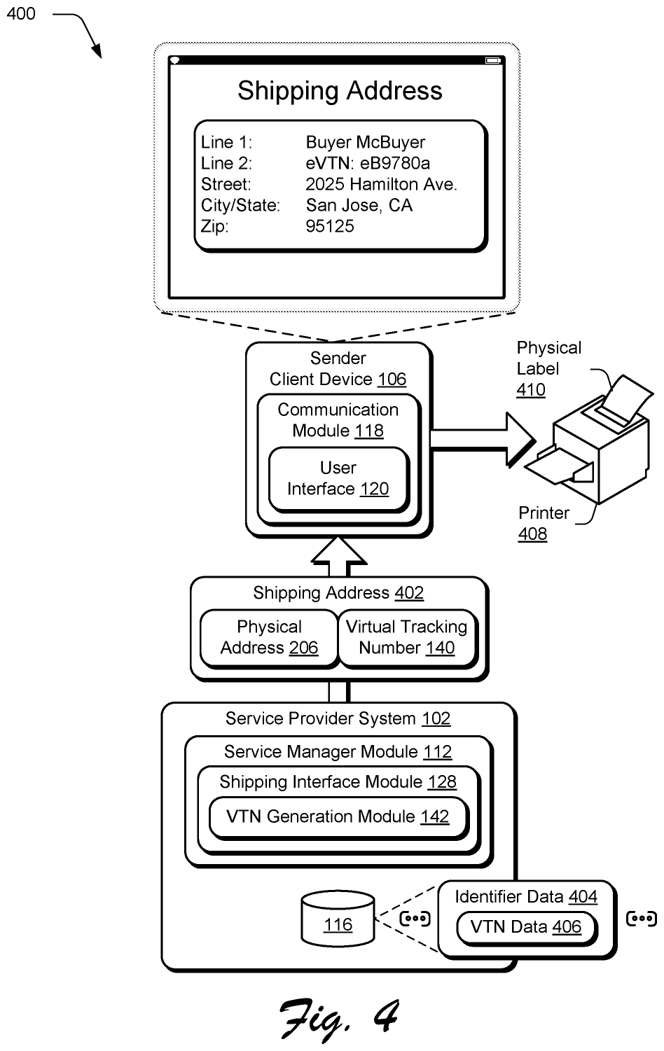

FIG. 4 depicts a system 400 in an example implementation in which a shipping address 402 is generated by a service provider system 102 that includes a VTN 140 as an integral part, thereof. Continuing with the previous example, the service provider system 102 receives the request to generate the shipping address 402, e.g., via a request to generate a shipping label. In response, a virtual tracking number (VTN) generation module 142 generates the VTN 140. The VTN generation module 142, for instance, accesses identifier data 404 associated with the physical item that is to be shipped, e.g., order number, product ID, and so forth. The VTN generation module 142 then associates VTN data 406 that describes the VTN 140 as associated with that physical item, which is maintained in a storage device 116.

The shipping address 402, as generated by the service provider system 102, is communicated via the network 110 and is illustrated as displayed in a user interface 120 of the sender client device 106. The shipping address 402 includes a physical address 206 containing information identifying where and how to ship the physical item. The physical address 206, for instance, include a name of an entity (e.g., person, business) that is to receive the physical item, a street address, a city, state (or providence/region/county), and zip code.

The shipping address 402 also includes the VTN 140 included as an integral part along with the physical address 206. The VTN 140, for instance, may be disposed as a second line in the address after the information identifying an entity that is to receive the physical item. In the illustrated example, the VTN 140 is configured using alphanumeric characters.

The VTN 140 identifies the physical item that is to be shipped and may also include information identifying the service provider system 102 (e.g., from a plurality of service provider systems) that is to receive this information. The VTN 140, however, does not include information in this example that is usable to determine characteristics of the physical address. The depicted version of the virtual tracking number in line 2 of the shipping address is “eVTN: eB9780a” in which “eB” identifies the service provider system 102 and “9780a” identifies the physical item, e.g., a transaction involving the physical item such as an order number. Other examples are also contemplated, e.g., use of other types of representations such as QR codes, bar codes (two or three dimensions), and so forth. The sender client device 106 employs the shipping address 402 to ship the physical item to a user associated with the recipient client device 108. This may be performed in a variety of ways, examples of which include use of a printer 408 to print a physical label 410 to be affixed to packaging used to ship the physical item, displayed in a user interface 120 to be copied into a user interface output by the shipping provider system 104 (e.g., to initiate shipping with that entity), and so forth. In this way, the VTN 140 is generated and associated with the shipping of the physical item automatically and without user intervention by a user of the sender client device 106.

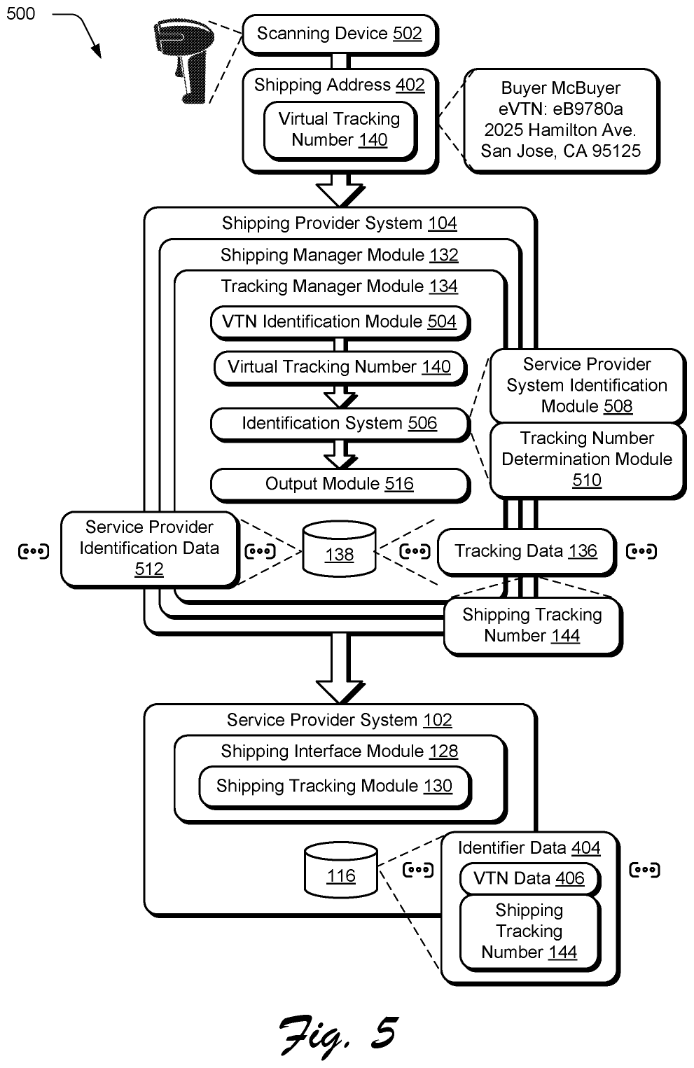

FIG. 5 depicts a system 500 in an example implementation in which a shipping provider system 104 detects the VTN 140 included as part of the shipping address 402, and in response, communicates a shipping tracking number 144 to the service provider system 102. The shipping tracking number 144 is associated with shipment of the physical item by the shipping provider system 104. In the illustrated example, a scanning device 502 of the shipping provider system 104 is used to scan a shipping address 402 included on packaging used to ship the physical item, e.g., through use of an optical scanner and optical character recognition. Other examples are also contemplated, such as in an instance in which the shipping address 402 and VTN 140 are entered by a user associated with the sender client device 106 via a user interface of the shipping provider system 104.

The shipping address 402 is then processed by the tracking manager module 134. As part of this, a VTN identification module 504 is employed to detect that the VTN 140 is included as part of the shipping address 402. The VTN 140, for instance, may include an identifier that indicates that the collection of alphanumeric characters is to function as the VTN 140. This may be implemented in a variety of ways, such as through inclusion of “eVTN” as a prefix in the address line (e.g., similar to “attn”), a portion of the VTN 140 as a unique identifier that identifies the service provider system 102 (e.g., “eB”), and so on.

The VTN 140 is then output by the VTN identification module 504 to an identification system 506 of the tracking manager module 134. The identification system 506 includes a service provider identification module 508 and a tracking number determination module 510 to identify how the VTN 140 related to shipping of the physical item as performed by the shipping provider system 104.

The service provider system identification module 508 is configured to identify the service provider system 102 that generated the VTN 140 and/or a service provider system that is to receive a shipping tracking number 144 based on the VTN 140. In other words, the VTN 140 may be generated by the service provider system 102 that is to receive data (e.g., tracking data 136) by leveraging the VTN 140 and/or some other entity that did not generate the VTN 140 but is to receive the tracking data 136, e.g., the receiving client device 108, another service provider system, and so forth.

The VTN 140 is configurable in a variety of ways. The VTN 140, for instance, may include an identifiable format, embedded code, and so forth that identifies the service provider system 102 from a plurality of service provider systems. In the illustrated example, the identification system 506 determines that “eB” portion of the VTN 140 identifies the service provider system through use of the service provider identification module 508. The service provider system identification module 508 then examines service provider identification data 512 to locate a network address, to which, a communication is to be sent. In this way, the identification system 506 identifies an entity that pertains to the VTN 140 and physical item that is being shipped by the shipping provider system 104.

The tracking number determination module 510 determines a shipping tracking number 144 associated with the shipping provider system 104. The shipping tracking number 144 is also used determine which portion of the tracking data 136 corresponds to the physical item being shipped. Continuing with the previous example, the tracking number determination module 510 determines the shipping tracking number 144 associated with the shipping address 402 and/or physical object scanned by the scanning device 502. The shipping tracking number 144, for instance, may have already been generated as part of configuring a shipping order to ship the physical item, may be generated to initiate generation of the shipping order, and so forth. The shipping tracking number 144 identifies a shipping transaction between users of the sender and recipient client devices 106, 108. In practice, for instance, the shipping tracking number is used to track a shipping status of the physical item from the sender to the recipient.

An output module 516 is employed by the shipping provider system 104 to form a communication for transmission over the network 110 to the service provider system. The communication is transmitted to the service provider system 102 based on service provider identification data 512 identified above. The communication also indicates that the VTN 140 as received by the shipping provider system 104 is associated with a shipping tracking number 144 used to track shipping status of the physical item by the shipping provider system 104 as described by the tracking data 136. As previously described, examples of information included as part of the tracking data 136 include a general shipping stage (e.g., label printed, picked up, in transit, out-for-delivery), times at which these stages have been initiated, corresponding locations at which these stages are achieved, characteristics of the physical item (e.g., size, weight, packing materials used), shipping cost, insurance information, and so forth.

The shipping tracking module 130, upon receipt of this communication from the shipping provider system 104 by the service provider system 102, associates the shipping tracking number 144 along with VTN data 406 as part of identifier data 404 maintained in a storage device 116. This may then be employed and/or disseminated by the service provider system 102 to track shipping of the physical item. This may be performed indirectly through the service provider system 102 and/or directly with the shipping provider system 104 by the sender client device 106 and/or the recipient client device, further discussion of which is included in the following example.

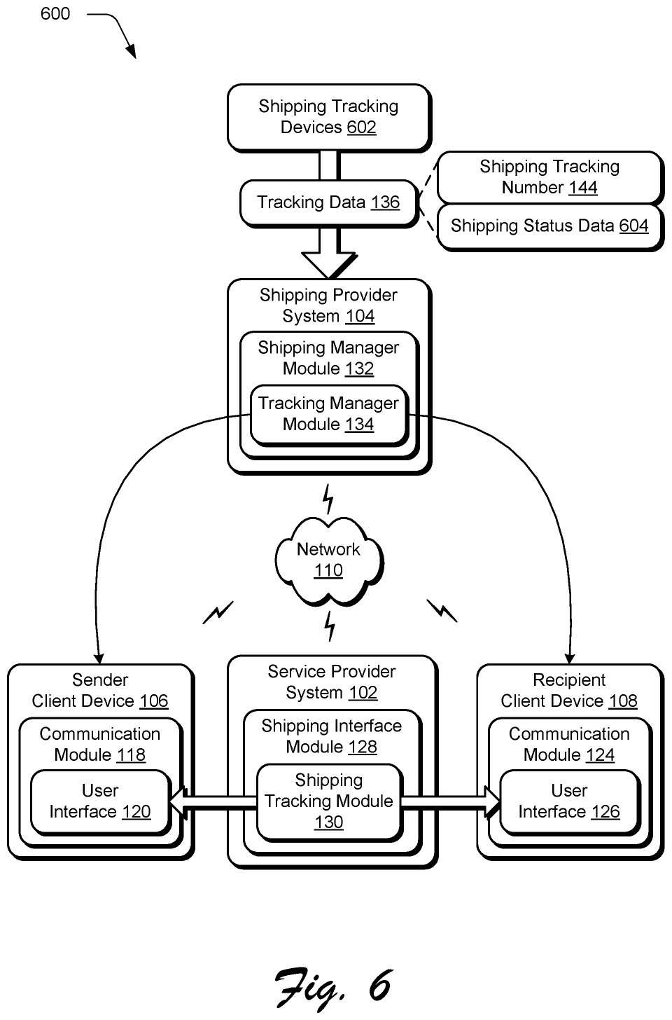

FIG. 6 depicts a system 600 in an example implementation in which a shipping tracking number 144 received from a shipping provider system 104 in response to identification of a VTN 140 is used to obtain tracking data 136 describing characteristics involved in shipping a physical item by the shipping provider system 104.

As part of shipping the physical item, the shipping provider system 104 may employ a variety of different shipping tracking device 602 that are configured to indicate shipping status, e.g., at different stages in the shipping journey. A physical label of the physical item, for instance, may be scanned by the shipping tracking device 602 when the physical item is obtained by the shipping provider system 104. A shipping tracking number 144 associated with the label is communicated along with shipping status data 604 (e.g., which identifies the shipping stage and/or shipping device being employed) by the shipping tracking device 602 as tracking data 136 to the shipping provider system 104. Additional scanning may be performed when the physical item is sorted and passed through various distribution stages from associated shipping tracking devices 602 until received at the specified destination, or not if shipping is not successful. This may include a variety of vehicles and processing devices by the shipping provider system 104 to make this possible. Therefore, as part of this process, the tracking manager module 134 collects tracking data 136 from these shipping tracking devices 602 that describes shipping status of the physical item.

Continuing with the previous example of FIG. 5, the service provider system has received the shipping tracking number 144 from the shipping provider system 104. In one example, the shipping tracking number 144 is communicated via the network 110 to the sender client device 106 and/or recipient client device 108 such that each of these entities may obtain tracking data 136 directly from the shipping provider system 104, e.g., via a user interface output by the shipping provider system 104. In another example, the shipping tracking module 130 of the service provider system 102 outputs a user interface viewable by the sender client device 106 and/or recipient client device 108 to view the tracking data 136. As a result, inclusion of the VTN 140 as part of the shipping address is leveraged by the service provider system 102 and shipping provider system 104 to automatically obtain tracking data 136 without user intervention. Accordingly, each of the different entities may realize a variety of different functionality made possible by the VTN 140 as further described in relation to the following procedures.

### Example Procedures

The following discussion describes techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-6.

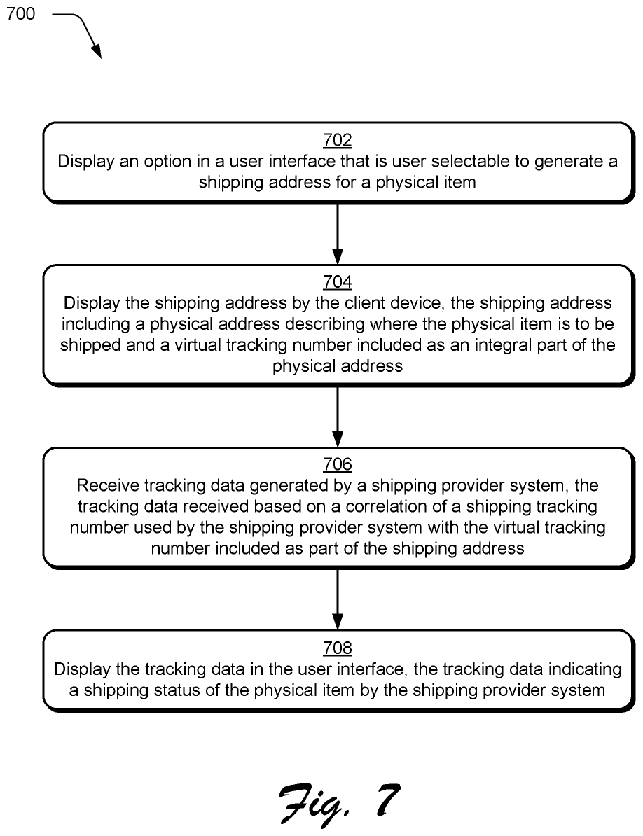

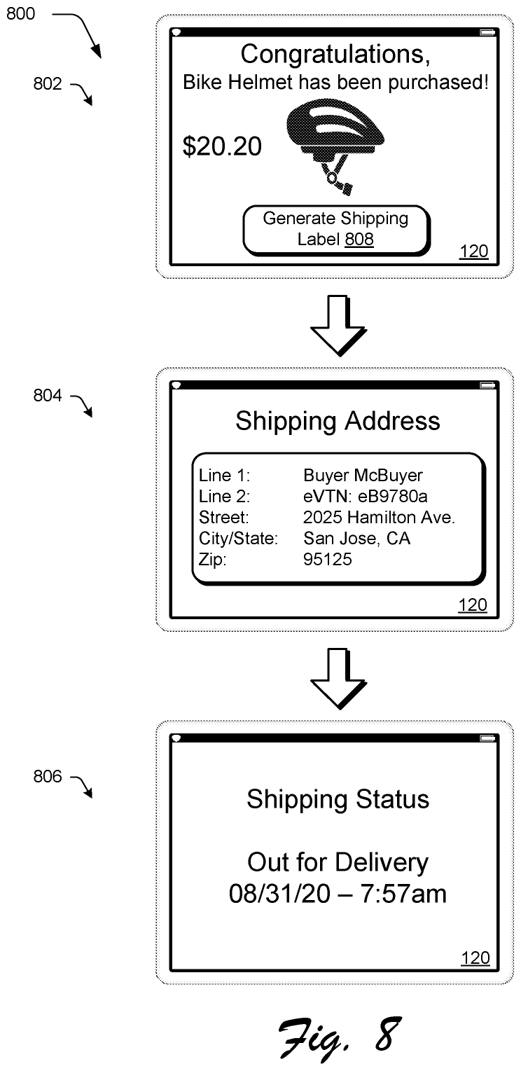

FIG. 7 depicts a procedure 700 in an example implementation in which a virtual tracking number is leveraged by a sender client device 106 as part of shipping a physical item as part of a digital service. FIG. 8 depicts a system 800 in an example implementation shown using first, second, and third stages 802, 804, 806 including selection of a physical item, display of a shipping address that includes the virtual tracking number as an integral part thereof, and display of tracking data.

To begin in this example, at the first stage 802 an option is displayed in a user interface that is user selectable to generate a shipping address for a physical item (block 702). The option depicted in the illustrated example is to generate a shipping label but other examples are also contemplated, such as to generate the shipping address itself alone, as part of printing a physical label, and so on.

At the second stage 804, a shipping address is displayed by the client device. The shipping address ins a physical address describing where the physical item is to be shipped and a virtual tracking number included as an integral part of the physical address (block 704). In the illustrated example, the virtual tracking number is included as a line within the address using alphanumeric characters, although other examples are also contemplated.

Tracking data is then received by the client device that is generated by a shipping provider system 104. The tracking data is received based on a correlation of a shipping tracking number used by the shipping provider system 104 with the VTN 140 included as part of the shipping address (block 706). The tracking data is then displayed in the user interface by the client device at the third stage 806, the tracking data indicating a shipping status of the physical item by the shipping provider system 104 (block 708). In this way, this data may be received by the sending client device automatically and without user intervention.

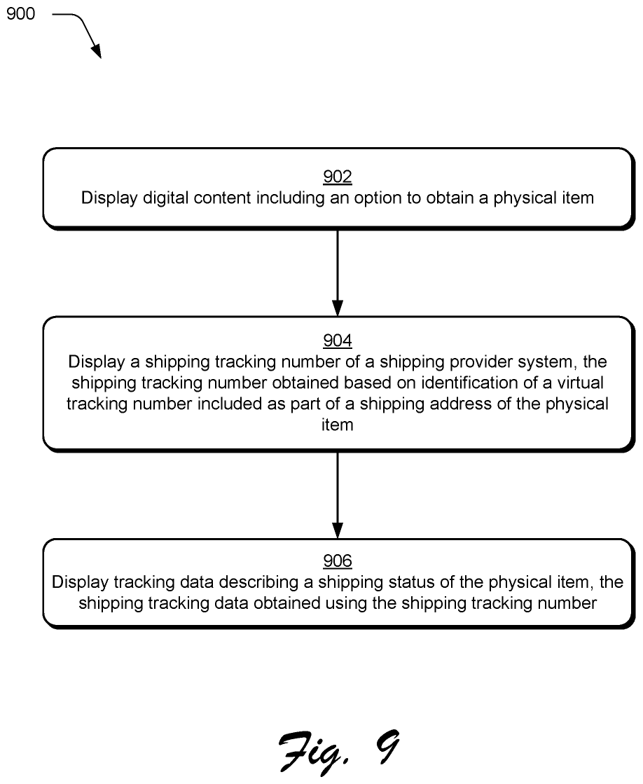

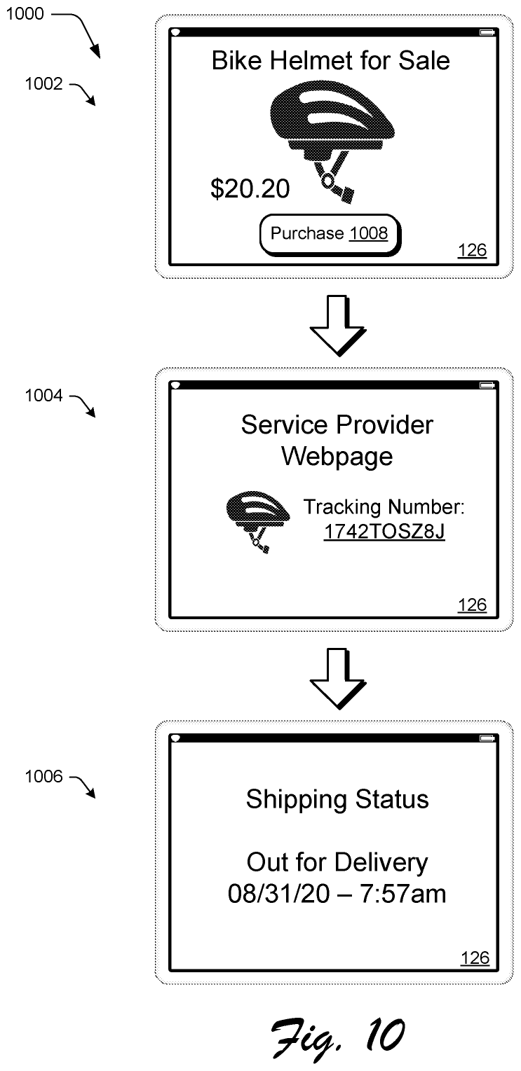

FIG. 9 depicts a procedure 900 in an example implementation in which a virtual tracking number is leveraged by a recipient client device 108 as part of shipping a physical item as part of a digital service. FIG. 10 depicts a system 1000 in an example implementation shown using first, second, and third stages 1002, 1004, 1006 including selection of a physical item to be obtained through interaction with digital content, display of a shipping tracking number obtained from a shipping provider system using the virtual tracking number, and display of tracking data.

In this example at the first stage 902, digital content is displayed by the recipient client device 108 in a user interface 126 that includes an option 1008 to obtain a physical item (block 1002). In the illustrated example, the option 1008 is configured to purchase the physical item, but other options not involving billing and purchase are also contemplated.

At the second stage 904, a shipping tracking number 144 of the shipping provider system 104 is displayed in a user interface 126. The shipping tracking number 144 is obtained based on identification of a VTN 140 included as part of the shipping address of the physical item (block 904) as described in relation to FIG. 5.

At the third stage 906, tracking data describing a shipping status of the physical item is displayed in the user interface 126, the shipping tracking data is obtained using the shipping tracking number (block 906). As previously described in relation to FIG. 6, this may be performed directly between the shipping provider system 104 and the recipient client device 108 or indirectly through the service provider system 102.

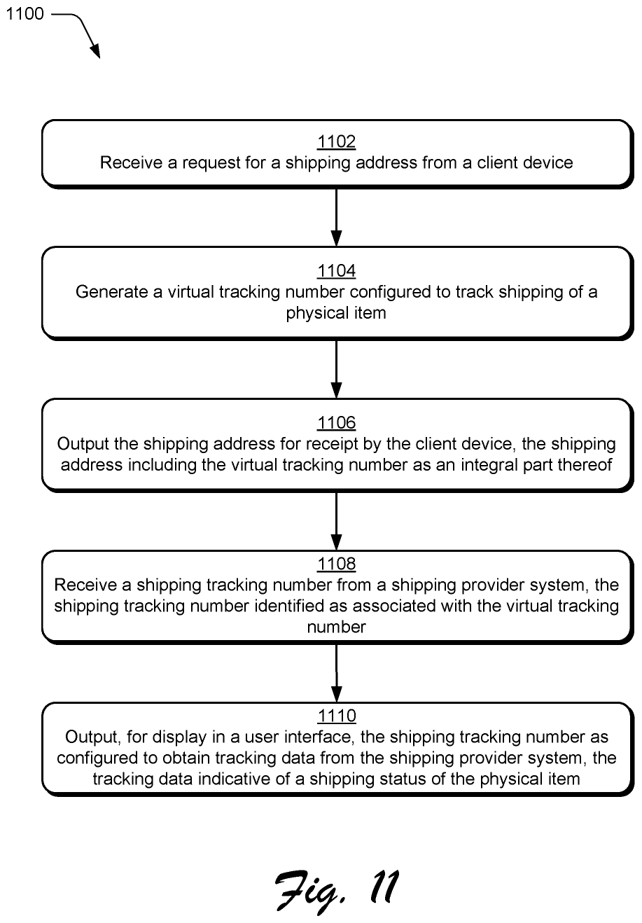

FIG. 11 depicts 1100 a procedure in an example implementation in which a service provider system generates and leverages a virtual tracking number. A request is received by the service provider system 102 for a shipping address from a client device 102 (block 1102), e.g., to generate a physical label, to generally obtain a physical address of an entity that is to receive the physical item, and so on.

In response, a VTN is generated automatically and without user intervention by the service provider system to tracking shipping of the physical item (block 1104). The VTN is configurable in a variety of ways, including the use of alphanumeric characters that are viewable along with the physical address used to generate the shipping address, an RFID tag, a QR code, a bar code, and so forth.

The shipping address is output by the service provider system for recipet by the client device. The shipping address includes the VTN as an integral part thereof (block 1106), e.g., is included within the text of the physical address. A shipping tracking number is then received from a shipping provider system 104. The shipping tracking number is identified as associated with the VTN 140 (block 1108). As a result, the service provider system 102 is made aware as to which physical item is associated with the shipping tracking number used by the shipping provider system 104. The shipping tracking number is then output for display in a user interface. The shipping tracking number is configured to obtain tracking data from the shipping provider system and the tracking data is indicative of a shipping status of the physical item (block 1110). A variety of other examples are also contemplated.

### Example System and Device

FIG. 12 illustrates an example system generally at 1200 that includes an example computing device 1202 that is representative of one or more computing systems and/or devices that may implement the various techniques described herein. This is illustrated through inclusion of the VTN generation module 142 and VTN 140. The computing device 1202 may be, for example, a server of a service provider, a device associated with a client (e.g., a client device), an on-chip system, and/or any other suitable computing device or computing system.

The example computing device 1202 as illustrated includes a processing system 1204, one or more computer-readable media 1206, and one or more I/O interface 1208 that are communicatively coupled, one to another. Although not shown, the computing device 1202 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1204 is representative of functionality to perform one or more operations using hardware. Accordingly, the processing system 1204 is illustrated as including hardware element 1210 that may be configured as processors, functional blocks, and so forth. This may include implementation in hardware as an application specific integrated circuit or other logic device formed using one or more semiconductors. The hardware elements 1210 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1206 is illustrated as including memory/storage 1212. The memory/storage 1212 represents memory/storage capacity associated with one or more computer-readable media. The memory/storage component 1212 may include volatile media (such as random access memory (RAM)) and/or nonvolatile media (such as read only memory (ROM), Flash memory, optical disks, magnetic disks, and so forth). The memory/storage component 1212 may include fixed media (e.g., RAM, ROM, a fixed hard drive, and so on) as well as removable media (e.g., Flash memory, a removable hard drive, an optical disc, and so forth). The computer-readable media 1206 may be configured in a variety of other ways as further described below.

Input/output interface(s) 1208 are representative of functionality to allow a user to enter commands and information to computing device 1202, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1202 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1202. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1202, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1210 and computer-readable media 1206 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1210. The computing device 1202 may be configured to implement particular instructions and/or functions corresponding to the software and/or hardware modules. Accordingly, implementation of a module that is executable by the computing device 1202 as software may be achieved at least partially in hardware, e.g., through use of computer-readable storage media and/or hardware elements 1210 of the processing system 1204. The instructions and/or functions may be executable/operable by one or more articles of manufacture (for example, one or more computing devices 1202 and/or processing systems 1204) to implement techniques, modules, and examples described herein.

The techniques described herein may be supported by various configurations of the computing device 1202 and are not limited to the specific examples of the techniques described herein. This functionality may also be implemented all or in part through use of a distributed system, such as over a “cloud” 1214 via a platform 1216 as described below.

The cloud 1214 includes and/or is representative of a platform 1216 for resources 1218. The platform 1216 abstracts underlying functionality of hardware (e.g., servers) and software resources of the cloud 1214. The resources 1218 may include applications and/or data that can be utilized while computer processing is executed on servers that are remote from the computing device 1202. Resources 1218 can also include services provided over the Internet and/or through a subscriber network, such as a cellular or Wi-Fi network.

The platform 1216 may abstract resources and functions to connect the computing device 1202 with other computing devices. The platform 1216 may also serve to abstract scaling of resources to provide a corresponding level of scale to encountered demand for the resources 1218 that are implemented via the platform 1216. Accordingly, in an interconnected device embodiment, implementation of functionality described herein may be distributed throughout the system 1200. For example, the functionality may be implemented in part on the computing device 1202 as well as via the platform 1216 that abstracts the functionality of the cloud 1214.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

1. A method implemented by a client device, the method comprising:
displaying, by the client device, an option in a user interface that is user selectable to generate, via a digital service provider system, a shipping address for a physical item, the digital service provider system being a separate entity from a shipping provider system;
displaying, via the user interface of the client device, the shipping address generated via the digital service provider system, the shipping address including a physical address describing where the physical item is to be shipped and a virtual tracking identifier included as an integral part of the physical address;
receiving, by the client device, tracking data generated by the shipping provider system, the shipping provider system being a separate entity from the digital service provider system, the tracking data received based on a correlation of a shipping tracking identifier used by the shipping provider system with the virtual tracking identifier included as part of the shipping address generated by the digital service provider system; and
displaying, by the client device, the tracking data in the user interface, the tracking data indicating a shipping status of the physical item by the shipping provider system.

2. The method as described in claim 1, wherein the physical address includes a name, street address, and zip code and the virtual tracking identifier is configured using alphanumeric characters disposed along with the physical address.

3. The method as described in claim 1, wherein the option is configured to generate a label for shipping the physical item that includes the shipping address.

4. The method as described in claim 1, wherein the virtual tracking identifier is included as a line within the shipping address and does not function to identify the physical address, to which, the physical item is to be shipped.

5. The method as described in claim 1, wherein the virtual tracking identifier is configured to identify the digital service provider system that is to receive the shipping tracking identifier that is used by the shipping provider system to track shipping of the physical item.

6. The method as described in claim 5, wherein the tracking data is received by the client device from the shipping provider system.

7. The method as described in claim 5, wherein the tracking data is received by the client device from the digital service provider system.

8. The method as described in claim 5, wherein the digital service provider system is configured to output digital content that supports user interaction to initiate a purchase of the physical item.

9. A digital service provider system separate from a shipping provider system, the digital service provider system comprising:
a processing system; and
a computer-readable storage medium having instructions stored thereon that, responsive to execution by the processing system, causes the processing system to perform operations including:
receiving a request for a shipping address from a client device;
generating a virtual tracking number configured to track shipping of a physical item;
outputting the shipping address for receipt by the client device, the shipping address including the virtual tracking number as an integral part thereof;
receiving a shipping tracking number from the shipping provider system, the shipping provider system being a separate entity from the digital service provider system, the shipping tracking number identified as associated with the virtual tracking number; and
outputting, for display in a user interface, the shipping tracking number as configured to obtain tracking data from the shipping provider system, the tracking data indicative of a shipping status of the physical item.

10. The service provider system as described in claim 9, the operations further comprising:
obtaining the tracking data from the shipping provider system based on the shipping tracking number; and
outputting the tracking data for display in the user interface by the client device that is to ship the physical item.

11. The digital service provider system as described in claim 9, the operations further comprising:
obtaining the tracking data from the shipping provider system based on the shipping tracking number; and
outputting the tracking data for display in a user interface by another a different client device that is to receive the physical item as shipping by the client device using the shipping provider system.

12. The digital service provider system as described in claim 9, the operations further comprising outputting digital content for display in a user interface, the digital content including an option to purchase the physical item.

13. The digital service provider system as described in claim 9, wherein the request is received responsive to user selection of an option to generate a physical label that includes the shipping address.

14. (canceled)

15. The digital service provider system as described in claim 9, wherein the virtual tracking number is configured to identify the digital service provider system from a plurality of digital service provider systems, the plurality of digital service provider systems being separate entities from the shipping provider system.

16. The digital service provider system as described in claim 9, wherein the virtual tracking number is included as a line within the shipping address and does not function to identify the physical address, to which, the physical item is to be shipped.

17. A shipping provider system comprising:
a virtual tracking number identification module implemented at least partially in hardware to detect a virtual tracking number included as part of a shipping address;
a service provider system identification module implemented at least partially in hardware to identify a digital service provider system based on the virtual tracking number, the digital service provider system being a separate entity from the shipping provider system;
a tracking number determination module implemented at least partially in hardware to identify a shipping tracking number used by the shipping provider system to track shipping status a physical item to a physical address included as part of the shipping address; and
an output module implemented at least partially in hardware to form a communication for receipt by the identified digital service provider system that is the separate entity from the shipping provider system, the communication indicating the shipping tracking number as associated with the virtual tracking number.

18. (canceled)

19. The shipping provider system as described in claim 17, wherein the virtual tracking number is configured to identify the digital service provider system from a plurality of digital service provider systems.

20. The shipping provider system as described in claim 17, wherein the virtual tracking number is included as a line within the shipping address and does not function to identify the physical address, to which, the physical item is to be shipped.

21. The method of claim 1, wherein the virtual tracking identifier includes embedded code that identifies the digital service provider system.

22. The method of claim 1, wherein the virtual tracking identifier includes a QR code.
